(19) United States
(12) Patent Application Publication
(10) Pub. No.: US 2005/0071317 A1
(43) Pub. Date: Mar. 31, 2005

(54) Method and apparatus for optimizing management of spare components for network infrastructure

(75) Inventors: Uma Chandrashekhar, Morganville, NJ (US); Chi-Hung Kelvin Chu, Holmdel, NJ (US); Ming Chi Chu, Hazlet, NJ (US); Steven H. Richman, Highland Park, NJ (US)

Correspondence Address: MOSER, PATTERSON & SHERIDAN L.L.P., 595 SHREWSBURY AVE, STE 100, FIRST FLOOR, SHREWSBURY, NJ, 07702, US

(73) Assignee: LUCENT TECHNOLOGIES INC.

(21) Appl. No.: 10/672,603

(22) Filed: Sep. 26, 2003

(51) Int. Cl. G06F 17/30

(52) U.S. Cl. 707/2

(57) ABSTRACT

Method and apparatus for optimizing spare component management for a network having a plurality of nodes is described. In one example, availability parameters associated with an inventory of spare components are obtained. A plurality of management configurations are determined in response to the availability parameters. Each management configuration includes at least one warehouse node selected from the plurality of nodes in the network and a quantity of spare components in the inventory that are to be stored at the at least one warehouse node.

### BACKGROUND OF THE INVENTION

1. Field of the Invention

The present invention generally relates to information systems and, more particularly, to optimizing management of spare components for network infrastructure, which includes determining number of spares and the correct geographical area to minimize impact of availability to the network.

2. Description of the Related Art

Presently, spare components for elements of network infrastructure are maintained at each location or node of the network. For example, spare components for communication equipment may be stored at each office, service location, warehouse, and central office, of a communications network. In addition, the number of spare components to be stored at a given location for a given network element is based on a recommendation of the equipment vendor. While some algorithms have been developed to determine the number of required spare components in accordance with the reliability of the equipment, such solutions typically address only the number of spares that should be stored at a location given the quantities of the network elements in service. Such “sparing solutions” do not account for repair times, distance traveled, minimum downtimes, capital expenditures, or customer satisfaction.

### SUMMARY OF THE INVENTION

These and other deficiencies of the prior art are addressed by the present invention of a method, apparatus, and computer readable medium for optimizing spare component management for a network having a plurality of nodes. In one embodiment of the invention, availability parameters associated with an inventory of spare components are also obtained. A plurality of management configurations are determined in response to the availability parameters. Each management configuration includes at least one warehouse node selected from the plurality of nodes in the network and a quantity of spare components in the inventory that are to be stored at the at least one warehouse node.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of a network;

FIG. 2 is a data flow diagram depicting an exemplary embodiment of a process for optimizing spare component management for a network;

FIG. 3 is a flow diagram depicting an exemplary embodiment of a warehouse and location optimization process; and

FIG. 4 is a block diagram depicting an exemplary embodiment of a computer suitable for implementing processes and methods described herein.

### DETAILED DESCRIPTION

The inventors have determined that as the communications industry becomes more competitive and capital becomes more constrained, it becomes imperative to optimize the reliability of the network by maintaining an accurate sparing solution. As such, a method and apparatus for optimizing spare component management for a network having a plurality of nodes is described. One or more aspects of the invention are related to optimizing spare component management within a telecommunications network. Those skilled in the art will appreciate, however, that the present invention may be employed to optimize spare component management in other types of networks having nodes dispersed within a particular region and elements requiring spare components.

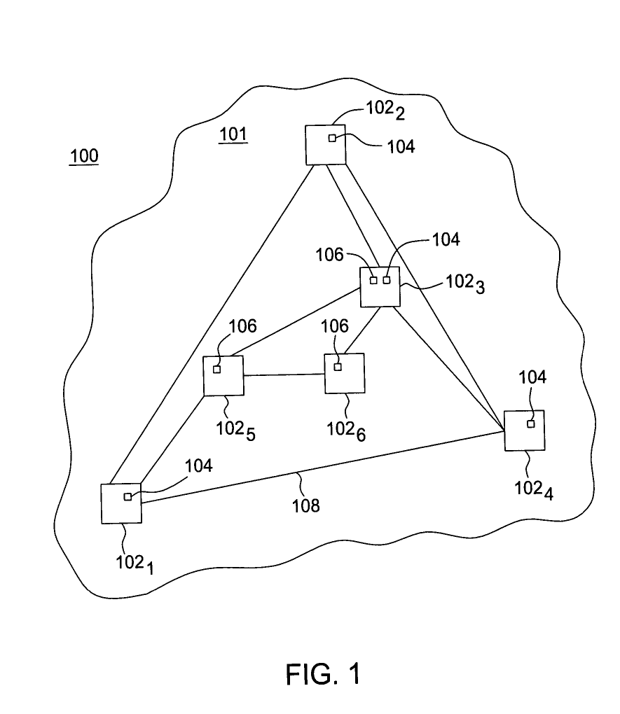

FIG. 1 is a block diagram depicting an exemplary embodiment of a network 100. The network 100 comprises a plurality of nodes 102, illustratively, nodes 102₁, through 102₆. Each of the nodes 102 is disposed at a different location within a region 101. In this exemplary embodiment, nodes 102₁ through 102₄ each comprise an in-service network portion 104 having in-service network components (“network components”). Nodes 102₃, 102₅, and 102₆ each comprise a warehouse portion 106 for storing spare network components (“spare components”). In this embodiment, the node 102₃ includes both an in-service network portion 104 and a warehouse portion 106. In general, the network 100 may comprise any number nodes that have an in-service network portion, a warehouse portion, or both. For example, in a telecommunications network, several of the nodes may be central offices (COs) having telephone switching equipment and others of the nodes may be warehouses for storing spare components. In addition, some of the COs may be capable of storing spare components.

The nodes 102 are logistically connected to one another via pathways 108. For example, spare components residing at the node 102₃ may be moved to the node 102₁ using the pathways 108. In this exemplary embodiment, not all of the nodes 102 are directly connected to one another via one of the pathways 108. As such, the distance between pairs of the nodes 102, and hence the time it takes to travel between pairs of the nodes 102, depends on the configuration of the pathways 108. In general, a given one of the nodes 102 may be logistically connected to one or more others of the nodes 102 via one or more of the pathways 108.

As used herein, the term “warehouse node” refers to any node of the network 100 having a warehouse portion (i.e., capable of storing spare components). The number of warehouse nodes in the network 100 is referred to herein as the “warehouse configuration”. For example, a given network may employ a distributed warehouse configuration in which each of the warehouse nodes in the network stores spare components. In another example, a given network may employ a centralized warehouse configuration in which one or more, but not all, of the warehouse nodes store spare components. In general, a warehouse configuration includes at least one warehouse node. In this exemplary embodiment, a centralized warehouse configuration is employed, where three of the nodes 102 are warehouse nodes.

Specifically, in this exemplary embodiment, nodes 102₃, 102₅, and 102₆ are warehouse nodes. Nodes 102₃, 102₅, and 102₆ each store a particular quantity of spare components for the network 100, where the total quantity of spare components comprises the inventory. The term “quantity”, as used herein, is meant to encompass any number of spare components including zero spare components. For purposes of clarity by example, the present example refers to “spare components” without regard to class, category, or type. In reality, however, a typical network may be defined by a multiplicity of different types of network components requiring spares, thus yielding a multiplicity of different types of spare components. As such, a warehouse node may store different quantities of spare components depending on the spare component types. Although the present example refers to a quantity of spare components without regard to different types of spare components, it is to be understood that a given inventory for a network may include multiple types of spare components of different quantities, as will be described below with respect to the warehouse spare and location optimization process 300.

A specific implementation of a warehouse configuration given a particular network of nodes, along with specific quantities of spare components to be stored at the selected warehouse nodes, is referred to herein as a “spare component management configuration” or simply a “management configuration”. That is, a management configuration comprises at least one warehouse node selected from the nodes of the network and a quantity of spare components in the inventory of the network to be stored at the at least one warehouse node. The optimal determination of a management configuration for a given network is discussed below with respect to the optimization process 200.

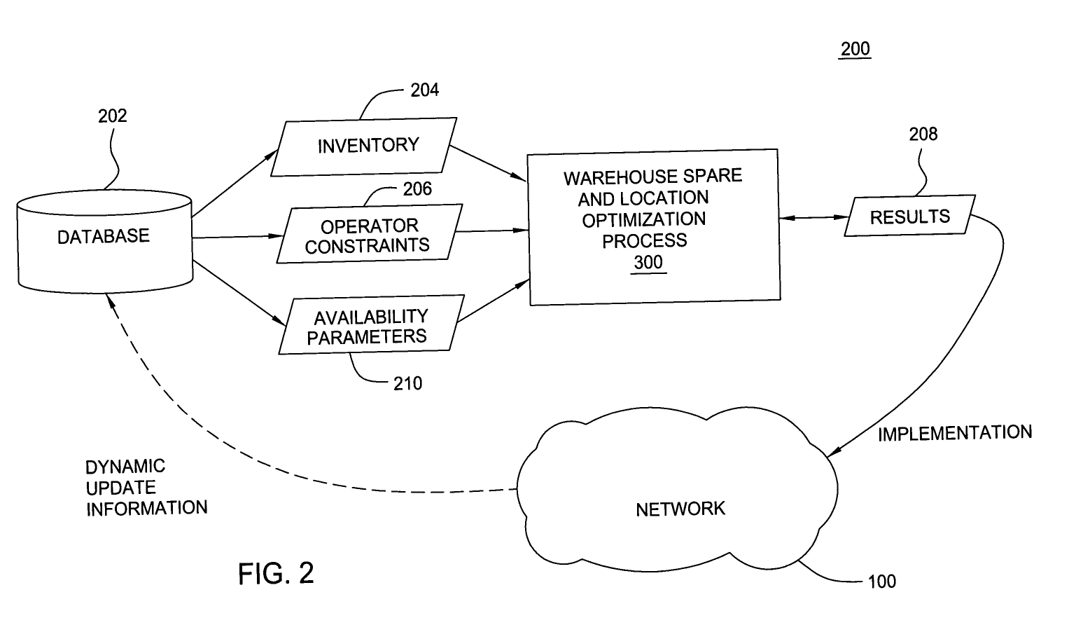

FIG. 2 is a data flow diagram depicting an exemplary embodiment of a process 200 for optimizing spare component management for a network. Inventory data (“inventory 204”), operator constraint data (“operator constraints 206”), and availability parameters 210 are stored in a database 202. The inventory 204 may include the quantity of spare components for the network and the current locations within the network that are storing the spare components. The availability parameters 210 include data that affects the availability of the spare components within the network. For example, the availability parameters 210 may include failure rates, minimum repair times, restocking times, stockout probabilities, delivery times, and like type availability parameters known in the art. The availability parameters 210 may include different data for each type of spare component that is to be warehoused within the network. The operator constraints 206 include data provided the network operator that represents minimum requirements for the warehousing solution. For example, the operator constraints 206 may include critical repair times related to service level agreements (SLAs) and target stockout probabilities.

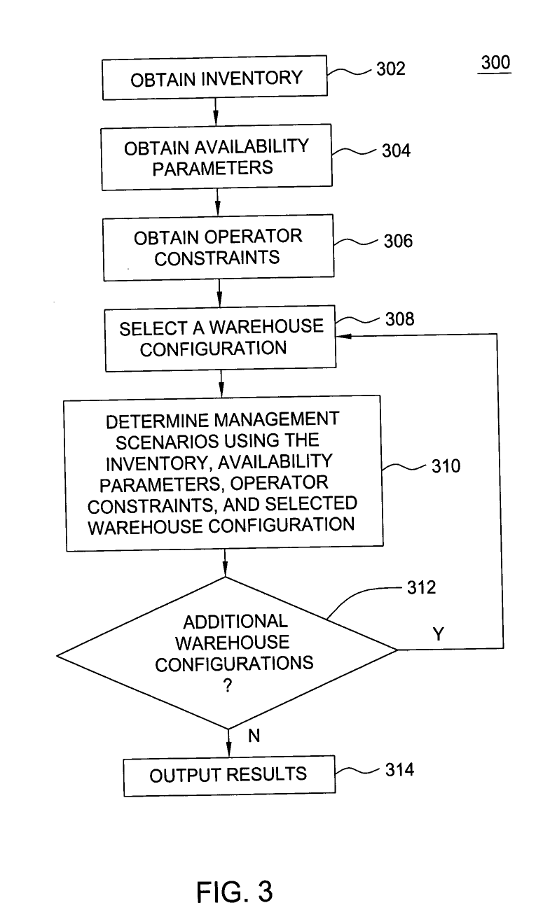

The inventory 204, the operator constraints 206, and the availability parameters 210 are provided to a warehouse spare and location optimization process 300 as parametric input. The warehouse spare and location optimization process 300 is described below with respect to FIG. 3. The warehouse spare and location optimization process 300 produces results 208. The results 208 may include, for example, minimum downtimes and the number of critical repair time violations for various management configurations for various warehouse configurations. That is, the results 208 may include data for multiple warehouse configurations (e.g., distributed, centralized with a single warehouse node, centralized with two warehouse nodes, etc). For each warehouse configuration, the results 208 may include data for multiple management configurations. The management configurations may include the quantities of spare components to be stored at the warehouse nodes of the network, as well as minimum downtimes, and critical repair time violations. The management configuration with the least minimum downtime and least violations of critical repair times may then be selected as the optimal management configuration for each warehouse configuration. In turn, the optimal warehouse configuration may be selected based on the optimal management configurations.

From the results 208, an optimal warehousing solution may be implemented within the network 100. After implementation of the warehousing solution, the parameters input to the warehouse spare and location optimization process 300 may change. For example, several of the availability parameters 210 may change due to the optimization provided by the selected warehousing solution. Thus, in one embodiment of the invention, the inventory 204, the operator constraints 206, and the availability parameters 210 stored within the database 202 may be dynamically updated during operation of the network after implementation of the selected warehousing solution. The process 200 may then be repeated for additional optimization of the warehousing solution.

FIG. 3 is a flow diagram depicting an exemplary embodiment of a warehouse and location optimization process 300. The process 300 begins at step 302, where an inventory is obtained. At step 304, availability parameters are obtained. At step 306, operator constraints are obtained. At step 308, a warehouse configuration is selected. At step 310, management configurations are determined using the inventory, availability parameters, operator constraints, and the selected warehouse configuration. At step 312, a determination is made as to whether additional warehouse configurations are to be selected. If so, the process 300 returns to step 308 and repeats. If not, the process 300 outputs results at step 314. For example, step 310 may be repeated for a distributed warehouse configuration and for a centralized warehouse configuration having various numbers of warehouse nodes.

The process 300 may be more thoroughly understood with reference to the following mathematical description of the warehouse and location optimization process. The process will be described first with respect to a distributed warehouse configuration and then with respect to a centralized warehouse configuration. For the distributed warehouse configuration, the inventory in the network may be represented as:

$$x = \begin{matrix}[ {x}_{1} & ⋯ & {x}_{i} & ⋯ & {{x}_{N} ]}^{T} =\end{matrix} [ \begin{matrix}{x}_{11} & ⋯ & {x}_{1 k} & ⋯ & {x}_{1 M} \\ ⋮ & & ⋮ & & ⋮ \\ {x}_{i1} & ⋯ & {x}_{ik} & ⋯ & {x}_{iM} \\ ⋮ & & ⋮ & & ⋮ \\ {x}_{N1} & ⋯ & {x}_{Nk} & ⋯ & {x}_{NM}\end{matrix} ] ,$$

where i represents the ith node in the network, k is the kth type of in-service network component (“inventory item”), xᵢₖ is the quantity of the kth in-service network element at the ith node that requires spare components, N is the total number of potential warehouse nodes, and M is the total number of inventory items. The inventory failure rates may be represented as:
λ=[λ₁ . . . λₖ . . . λ_{M}],
where λₖ is the failure rate for the kth inventory item and is expressed in units of failures in time (FIT) (e.g., equal to 10⁻⁹ failures/hour). The expected failures for the network is then given by:

$$f = \begin{matrix}[ {f}_{1} & ⋯ & {f}_{i} & ⋯ & {{f}_{N} ]}^{T} =\end{matrix} [ \begin{matrix}{f}_{11} & ⋯ & {f}_{1 k} & ⋯ & {f}_{1 M} \\ ⋮ & & ⋮ & & ⋮ \\ {f}_{i1} & ⋯ & {f}_{ik} & ⋯ & {f}_{iM} \\ ⋮ & & ⋮ & & ⋮ \\ {f}_{N1} & ⋯ & {f}_{Nk} & ⋯ & {f}_{NM}\end{matrix} ] ,$$

where fᵢₖ=xᵢₖ·λₖ is the total number of failures per hour for the kth inventory item at the ith node of the network. The minimum repair times may be represented as follows:

$$t = \begin{matrix}[ {t}_{1} & ⋯ & {t}_{i} & ⋯ & {{t}_{N} ]}^{T} =\end{matrix} [ \begin{matrix}{t}_{11} & ⋯ & {t}_{1 k} & ⋯ & {t}_{1 M} \\ ⋮ & & ⋮ & & ⋮ \\ {t}_{i1} & ⋯ & {t}_{ik} & ⋯ & {t}_{iM} \\ ⋮ & & ⋮ & & ⋮ \\ {t}_{N1} & ⋯ & {t}_{Nk} & ⋯ & {t}_{NM}\end{matrix} ] ,$$

where tᵢₖ is the minimum repair time for the kth inventory item at the ith node of the network.

The quantity of spare components and the stockout probabilities for the network may be represented as follows:

$$\begin{matrix}s = g ( {a}_{i} \cdot {P}_{t} ) \begin{matrix}[ {s}_{1} & ⋯ & {s}_{i} & ⋯ & {{s}_{N} ]}^{T} =\end{matrix} [ \begin{matrix}{s}_{11} & ⋯ & {s}_{1 k} & ⋯ & {s}_{1 M} \\ ⋮ & & ⋮ & & ⋮ \\ {s}_{i1} & ⋯ & {s}_{ik} & ⋯ & {s}_{iM} \\ ⋮ & & ⋮ & & ⋮ \\ {s}_{N1} & ⋯ & {s}_{Nk} & ⋯ & {s}_{NM}\end{matrix} ] \\ p = h ( {a}_{i} \cdot {P}_{t} ) \begin{matrix}[ {p}_{1} & ⋯ & {p}_{i} & ⋯ & {{p}_{N} ]}^{T} =\end{matrix} [ \begin{matrix}{s}_{11} & ⋯ & {s}_{1 k} & ⋯ & {s}_{1 M} \\ ⋮ & & ⋮ & & ⋮ \\ {s}_{i1} & ⋯ & {s}_{ik} & ⋯ & {s}_{iM} \\ ⋮ & & ⋮ & & ⋮ \\ {s}_{N1} & ⋯ & {s}_{Nk} & ⋯ & {s}_{NM}\end{matrix} ]\end{matrix} ,$$

where aᵢ=Nᵢρᵢτ, Pₜ is the target stockout probability, sᵢₖ is the quantity of spare components for the kth inventory item at the ith node of the network, and pᵢₖ is the stockout probability for the kth inventory item at the ith node of the network. The variable aᵢ is the quantity of spare components to be replenished for the ith node of the network, Nᵢ is the in-service population of the spare components served by the sparing pool for the ith node of the network, ρᵢ is the spare component removal rate (e.g., per 10⁹ hours) for the ith node of the network, and τ is the mean time to restock a spare component.

Operators g and h are the Erlang-C spare and stockout probability functions defined below. The g function returns the quantity of spare components, sᵢₖ, for each inventory item, k, for each node, i. The h function returns the stockout probabilities, pₛₒ, of each inventory item, k, at each node, i. The following Erlang-C equation is used to determine the quantity of spare components and stockout probabilities for the inventory:

$${p}_{so} = \frac{\frac{{a}_{i}^{{s}_{i}}}{{s}_{i} ! ( 1 - {a}_{i} / {s}_{i} )}}{\frac{{a}_{i}^{{s}_{i}}}{{s}_{i} ! ( 1 - {a}_{i} / {s}_{i} )} + {\sum }_{k = 0}^{{s}_{i} - 1} \frac{{a}_{i}^{k}}{k !}} .$$

The quantity of spares is increased until the stockout probability, pₛₒ, is equal to or less than the target stockout probability, Pₜ. The total number of spares required for the network is given by:

$${\sum }_{k = 1}^{M} {\sum }_{i = 1}^{N} {s}_{ik} .$$

The inventory downtime for available spare components is given by:

$${r}^{s} = \begin{matrix}[ {r}_{1}^{s} & ⋯ & {r}_{i}^{s} & ⋯ & {{r}_{N}^{s} ]}^{T} =\end{matrix} [ \begin{matrix}{t}_{11} {f}_{11} & ⋯ & {t}_{1 k} {f}_{1 k} & ⋯ & {t}_{1 M} {f}_{1 M} \\ ⋮ & & ⋮ & & ⋮ \\ {t}_{i1} {f}_{il} & ⋯ & {t}_{ik} {f}_{ik} & ⋯ & {t}_{iM} {f}_{i M} \\ ⋮ & & ⋮ & & ⋮ \\ {t}_{N1} {f}_{N1} & ⋯ & {t}_{Nk} {f}_{Nk} & ⋯ & {t}_{NM} {f}_{NM}\end{matrix} ] .$$

The inventory downtime for unavailable or out-of-stock spare components is given by:

$${r}^{\overline{s}} = \begin{matrix}[ {r}_{1}^{\overline{s}} & ⋯ & {r}_{i}^{\overline{s}} & ⋯ & {{r}_{N}^{\overline{s}} ]}^{T} =\end{matrix} [ \begin{matrix}{τ}_{1} {f}_{11} & ⋯ & {τ}_{k} {f}_{1 k} & ⋯ & {τ}_{M} {f}_{1 M} \\ ⋮ & & ⋮ & & ⋮ \\ {τ}_{1} {f}_{il} & ⋯ & {τ}_{k} {f}_{ik} & ⋯ & {τ}_{M} {f}_{i M} \\ ⋮ & & ⋮ & & ⋮ \\ {τ}_{1} {f}_{N1} & ⋯ & {τ}_{k} {f}_{Nk} & ⋯ & {τ}_{M} {f}_{NM}\end{matrix} ] ,$$

where τₖ is the restocking time for the kth inventory item. The total inventory downtime may then be expressed as:

$$r = \begin{matrix}[ {r}_{1} & ⋯ & {r}_{i} & ⋯ & {{r}_{N} ]}^{T} =\end{matrix} [ \begin{matrix}{r}_{11} & ⋯ & {r}_{1 k} & ⋯ & {r}_{1 M} \\ ⋮ & & ⋮ & & ⋮ \\ {r}_{i1} & ⋯ & {r}_{ik} & ⋯ & {r}_{iM} \\ ⋮ & & ⋮ & & ⋮ \\ {r}_{N1} & ⋯ & {r}_{Nk} & ⋯ & {r}_{NM}\end{matrix} ] ,$$

where rᵢₖ=tᵢₖfᵢₖ(1−pᵢₖ)+τᵢₖfᵢₖpᵢₖ is the total inventory downtime for the kth inventory item at the ith node of the network. The total downtime for the network under the distributed warehousing configuration is then given by:

$${DT}^{D} = {\sum }_{k = 1}^{M} {\sum }_{i = 1}^{N} {r}_{ik} .$$

For a centralized warehouse configuration having a single warehouse node, the inventory, failure rates, and expected failures may be represented as described above (i.e., the x-matrix, the λ-vector, and the f-matrix, respectively). In addition, the quantity of spare components (s-matrix) and the stockout probabilities (p-matrix) for the network may be represented substantially as described above. However, unlike the distributed warehouse configuration, the elements in each row of the s-matrix provide the total quantity of spare components for each inventory item for each of the possible warehouse nodes, rather than the quantity of spare components stored at each node of the network.

The inventory repair times are the same as those of the distributed warehouse configuration, since the repair times are not dependent on the type of warehouse configuration. The minimum repair times may be represented as:

$${t}^{r} = {[ \begin{matrix}{t}_{1}^{r} & ⋯ & {t}_{i}^{r} & ⋯ & {t}_{N}^{r}\end{matrix} ]}^{T} = [ \begin{matrix}{t}_{11}^{r} & ⋯ & {t}_{1 k}^{r} & ⋯ & {t}_{1 M}^{r} \\ ⋮ & & ⋮ & & ⋮ \\ {t}_{i1}^{r} & ⋯ & {t}_{ik}^{r} & ⋯ & {t}_{iM}^{r} \\ ⋮ & & ⋮ & & ⋮ \\ {t}_{N1}^{r} & ⋯ & {t}_{Nk}^{r} & ⋯ & {t}_{NM}^{r}\end{matrix} ] ,$$

where tᵢₖ^{r} is the repair time for the kth inventory item at the ith potential warehouse node. The algorithm for the centralized warehouse configuration may also take into account the delivery times. The inventory delivery times from the mth (m ranges from 1 to N, to total number of nodes in the network) potential warehouse node to each faulted location may be represented as follows:

$$d = {[ \begin{matrix}{d}_{1} & ⋯ & {d}_{i} & ⋯ & {d}_{N}\end{matrix} ]}^{T} = [ \begin{matrix}{d}_{11} & ⋯ & {d}_{1 j} & ⋯ & {d}_{1 N} \\ ⋮ & & ⋮ & & ⋮ \\ {d}_{i1} & ⋯ & {d}_{ij} & ⋯ & {d}_{i N} \\ ⋮ & & ⋮ & & ⋮ \\ {d}_{N1} & ⋯ & {d}_{Nj} & ⋯ & {d}_{NN}\end{matrix} ] ,$$

where i is the warehouse node and j is the location where the spare is needed. The total repair time may then be computed for each potential warehouse node in the network. Thus, the total repair time associated with the mth potential warehouse node is given by:

$$\begin{matrix}{t}^{m} = {[ \begin{matrix}{t}_{1}^{m} & ⋯ & {t}_{i}^{m} & ⋯ & {t}_{N}^{m}\end{matrix} ]}^{T} \\ = [ \begin{matrix}{t}_{11}^{r} & ⋯ & {t}_{1 k}^{r} & ⋯ & {t}_{1 M}^{r} \\ ⋮ & & ⋮ & & ⋮ \\ {t}_{i1}^{r} & ⋯ & {t}_{ik}^{r} & ⋯ & {t}_{iM}^{r} \\ ⋮ & & ⋮ & & ⋮ \\ {t}_{N1}^{r} & ⋯ & {t}_{Nk}^{r} & ⋯ & {t}_{NM}^{r}\end{matrix} ] + [ \begin{matrix}{d}_{m1} & ⋯ & {d}_{m1} & ⋯ & {d}_{m1} \\ ⋮ & & ⋮ & & ⋮ \\ {d}_{m i} & ⋯ & {d}_{m i} & ⋯ & {d}_{m i} \\ ⋮ & & ⋮ & & ⋮ \\ {d}_{m N} & ⋯ & {d}_{m N} & ⋯ & {d}_{m N}\end{matrix} ] \\ = [ \begin{matrix}{t}_{11} & ⋯ & {t}_{1 k} & ⋯ & {t}_{1 M} \\ ⋮ & & ⋮ & & ⋮ \\ {t}_{i1} & ⋯ & {t}_{ik} & ⋯ & {t}_{iM} \\ ⋮ & & ⋮ & & ⋮ \\ {t}_{N1} & ⋯ & {t}_{Nk} & ⋯ & {t}_{NM}\end{matrix} ]\end{matrix}$$

where tᵢₖ=tᵢₖ^{r}+dₘᵢ.

As described above, the network operator may provide critical repair times for each inventory item. A critical repair time (CRT) is the minimum time in which a particular inventory item must be replaced. Each tᵢₖ must therefore satisfy the CRT for the kth inventory item (i.e., tᵢₖ≦CRTₖ). Violation of CRT occurs whenever tᵢₖ>CRTₖ. The number of violations for the mth potential warehouse node is therefore given by:

$$\begin{matrix}{v}^{m} = {[ \begin{matrix}{v}_{i}^{m} & ⋯ & {v}_{k}^{m} & ⋯ & {v}_{M}^{m}\end{matrix} ]}^{T} \\ = {[ \begin{matrix}{\sum }_{i = 1}^{N} u ( {t}_{i1} ) & ⋯ & {\sum }_{i = 1}^{N} u ( {t}_{ik} ) & ⋯ & {\sum }_{i = 1}^{N} u ( {t}_{iM} )\end{matrix} ]}^{T} ,\end{matrix}$$

where

$$\begin{matrix}u ( {t}_{ik} ) = 1 if {t}_{ik} > {CRT}_{k} \\ = 0 if {t}_{ik} \leq {CRT}_{k}\end{matrix} .$$

If spares are available, the downtime for the kth inventory item at the ith node is:

$$[ \begin{matrix}{t}_{11} {f}_{11} & ⋯ & {t}_{lk} {f}_{lk} & ⋯ & {t}_{lM} {f}_{lm} \\ ⋮ & & ⋮ & & ⋮ \\ {t}_{il} {f}_{il} & ⋯ & {t}_{ik} {f}_{ik} & ⋯ & {t}_{iM} {f}_{iM} \\ ⋮ & & ⋮ & & ⋮ \\ {t}_{Nl} {f}_{Nl} & ⋯ & {t}_{Nk} {f}_{Nk} & ⋯ & {t}_{NM} {f}_{NM}\end{matrix} ]$$

The inventory downtime for each inventory item for the mth potential warehouse node may be represented as follows:

$$\begin{matrix}{r}^{mS} = [ \begin{matrix}{\sum }_{i = 1}^{N} {t}_{i1} {f}_{i1} & ⋯ & {\sum }_{i = 1}^{N} {t}_{ik} {f}_{ik} & ⋯ & {\sum }_{i = 1}^{N} {t}_{iM} {f}_{iM}\end{matrix} ] \\ = [ \begin{matrix}{r}_{1}^{mS} & ⋯ & {r}_{k}^{mS} & ⋯ & {r}_{M}^{mS}\end{matrix} ]\end{matrix}$$

If spares are unavailable, the downtime for the kth inventory item at the ith node is:

$$[ \begin{matrix}{τ}_{1} {f}_{11} & ⋯ & {τ}_{k} {f}_{1 k} & ⋯ & {τ}_{M} {f}_{1 M} \\ ⋮ & & ⋮ & & ⋮ \\ {τ}_{1} {f}_{i1} & ⋯ & {τ}_{k} {f}_{ik} & ⋯ & {τ}_{M} {f}_{iM} \\ ⋮ & & ⋮ & & ⋮ \\ {τ}_{1} {f}_{N1} & ⋯ & {τ}_{k} {f}_{Nk} & ⋯ & {τ}_{M} {f}_{NM}\end{matrix} ] ,$$

where τₖ is the restocking time for the kth inventory item. The inventory downtime for each inventory item for the mth potential warehouse node may be represented by:

$$\begin{matrix}{r}^{m \overline{S}} = [ \begin{matrix}{\sum }_{i = 1}^{N} {τ}_{1} {f}_{i1} & ⋯ & {\sum }_{i = 1}^{N} {τ}_{k} {f}_{ik} & ⋯ & {\sum }_{i = 1}^{N} {τ}_{M} {f}_{iM}\end{matrix} ] \\ = [ \begin{matrix}{r}_{1}^{m \overline{S}} & ⋯ & {r}_{k}^{m \overline{S}} & ⋯ & {r}_{M}^{m \overline{S}}\end{matrix} ]\end{matrix}$$

The total inventory downtime for the mth potential warehouse is given by:
r^{m}=[rₗ^{m} . . . rₖ^{m} . . . r_{M}^{m}]
rₖ^{m}=rₖ^{mS}(1−pₘₖ)+rₖ^{m\overline{S}}pₘₖ
The total inventory downtime for all potential warehouse nodes may then be expressed as:

$$r = {[ \begin{matrix}{r}_{1} & ⋯ & {r}_{m} & ⋯ & {r}_{N}\end{matrix} ]}^{T} = [ \begin{matrix}{r}_{11} & ⋯ & {r}_{1 k} & ⋯ & {r}_{1 M} \\ ⋮ & & ⋮ & & ⋮ \\ {r}_{m1} & ⋯ & {r}_{mk} & ⋯ & {r}_{m M} \\ ⋮ & & ⋮ & & ⋮ \\ {r}_{N1} & ⋯ & {r}_{Nk} & ⋯ & {r}_{NM}\end{matrix} ] ,$$

such that the total downtime for the mth potential warehouse node is:

$${\sum }_{k = 1}^{M} {r}_{m k} .$$

The total downtime for the network using the centralized warehouse configuration is given by:

$${DT}^{c} = {[ \begin{matrix}{\sum }_{k = 1}^{M} {r}_{1 k} & ⋯ & {\sum }_{k = 1}^{M} {r}_{m k} & ⋯ & {\sum }_{k = 1}^{M} {r}_{Nk}\end{matrix} ]}^{T}$$

The ranking of total downtimes for the potential warehouse nodes is given by:

$${R}^{C} = {Rank [ {\sum }_{k = 1}^{M} {r}_{1 k} ⋯ {\sum }_{k = 1}^{M} {r}_{mk} ⋯ {\sum }_{k = 1}^{M} {r}_{Nk} ]}^{T} .$$

The computation for a centralized warehouse configuration having two warehouse nodes, m and n, is similar to that of a single warehouse node centralized warehouse configuration. For a single warehouse node system, the total number of potential warehouse nodes is equal to N, assuming that all nodes in the network can be considered as warehouse nodes. For a two-warehouse node system, however, the maximum number of potential warehouse node combinations is given by:

$$C = \frac{N !}{( N - r ) ! r !} ,$$

where r is the number of nodes considered at a time (e.g., 2). If the total number of potential warehouse nodes is six (i.e., N=6), the total number of potential warehouse node combinations is 15 for a two-warehouse node system.

The inventory repair times and delivery times may be represented as shown above for the centralized warehouse configuration having a single warehouse node. Assume that there are q scenarios ranging from 1 to C. The shortest delivery times from potential warehouse nodes m or n to the faulted location for the qth scenario is given by:
d^{q}=[d₁^{q} . . . dᵢ^{q} . . . d_{N}^{q}]^{T}=[min(dₘ₁,dₙ₁) . . . mindₘᵢ,dₙᵢ) . . . min(d_{mN},d_{nN})]^{T}
The spare components for each inventory item, k, must now be stored in either the mth or nth potential warehouse nodes. The following matrix keeps tracking of where the spare components should be stored:
I^{q}=[I₁^{q} . . . Iᵢ^{q} . . . I_{N}^{q}]^{T},
where

$$\begin{matrix}{I}_{i}^{q} = 1 if {d}_{ni} \geq {d}_{mi} ; warehouse node 1 \\ = 2 if {d}_{mi} > {d}_{ni} ; warehouse node 2\end{matrix} .$$

The spare components and the stockout probabilities for the two warehouse node centralized warehouse configuration may be determined as follows:

$${N}_{1 k}^{q} = {\sum }_{i = 1}^{N} {x}_{ik} {u}_{1 i} ; {N}_{2 k}^{q} = {\sum }_{i = 1}^{N} {x}_{ik} {u}_{2 i} , \\ where$$

$$\begin{matrix}{I}_{i}^{q} = 1 if {u}_{1 i} = 1 ; {u}_{2 i} = 0 \\ = 2 if {u}_{1 i} = 0 ; {u}_{2 i} = 1\end{matrix} .$$

In addition,
aᵢₖ^{q}=ρₖτₖ(N₁ₖ^{q}); a₂ₖ^{q}=ρₖτₖ(N₂ₖ^{q}),
where a₁ₖ^{q},a₂ₖ^{q} is the total number of inventory items to be replenished at nodes m and n; N₁ₖ^{q},N₂ₖ^{q} is the in-service population of the kth inventory item served by the sparing pool at nodes m and n; ρₖ is the removal rate of the kth inventory item (e.g., per 10⁹ hours); and τₖ is the time to restock the kth inventory item. The quantity of spare components is then given by:
s₁^{q}=[s₁₁^{q} . . . s₁ₖ^{q} . . . s_{1M}^{q}]
s₂^{q}=[s₂₁^{q} . . . s₂ₖ^{q} . . . s_{2M}^{q}];
s₁ₖ^{q}=g(a₁ₖ^{q},Pₜₖ)
s₂ₖ^{q}=g(a₂ₖ^{q},Pₜₖ)
and the stockout probabilities are given by:
p₁^{q}=[p₁₁^{q} . . . p₁ₖ^{q} . . . p_{1M}^{q}]
p₂^{q}=[p₂₁^{q} . . . p₂ₖ^{q} . . . p_{2M}^{q}],
p₁ₖ^{q}=h(a₁ₖ^{q},Pₜₖ)
p₂ₖ^{q}=h(a₂ₖ^{q},Pₜₖ)
where Pₜₖ is the target stockout probability for the kth inventory item, and where g and h are the Erlang-C spare and stockout probability functions, as described above. Unlike the single node centralized warehouse configuration, two spare pools are kept for the inventory items to replenish failed items at different nodes. Since the total number of in-service inventory items each node has to protect is dependent on the shortest delivery time from the spare pool to the faulted location, it therefore changes for each scenario, q. Spare and stockout probability matrices, s and p, must therefore by computed for each scenario, q, and cannot be computed ahead of time.

The total repair times from warehouse nodes m or n may be represented as:

$${t}^{q} = {[ \begin{matrix}{t}_{1} & ⋯ & {t}_{i} & ⋯ & {t}_{N}\end{matrix} ]}^{T} = [ \begin{matrix}{t}_{11}^{q} & ⋯ & {t}_{1 k}^{q} & ⋯ & {t}_{1 M}^{q} \\ ⋮ & & ⋮ & & ⋮ \\ {t}_{i1}^{q} & ⋯ & {t}_{ik}^{q} & ⋯ & {t}_{iM}^{q} \\ ⋮ & & ⋮ & & ⋮ \\ {t}_{N1}^{q} & ⋯ & {t}_{Nk}^{q} & ⋯ & {t}_{NM}^{q}\end{matrix} ] ,$$

where tᵢₖ^{q}=tᵢₖ^{q}+dᵢ^{q}, where d is the delivery time. Each tᵢₖ^{q} must satisfy the CRT for the inventory item, k. The number of violations for each warehouse node located at node i is therefore:

$${v}^{q} = {[ {\sum }_{k = 1}^{M} {v}_{1 k} ⋯ {\sum }_{k = 1}^{M} {v}_{ik} ⋯ {\sum }_{k = 1}^{M} {v}_{Nk} ]}^{T} ,$$

where

$$\begin{matrix}{v}_{ik} = \begin{matrix}1 & if & {t}_{ik}^{q} > {CRT}_{k}\end{matrix} \\ = \begin{matrix}0 & if & {t}_{ik}^{q} \leq {CRT}_{k}\end{matrix}\end{matrix} .$$

The inventory downtime for a 2-warehouse node centralized warehouse configuration may be represented as shown below. If spares are available, the downtime for the kth inventory item at the ith location is:

$$[ \begin{matrix}{t}_{ll}^{q} {f}_{ll} & ⋯ & {t}_{lk}^{q} {f}_{lk} & ⋯ & {t}_{lM}^{q} {f}_{lM} \\ ⋮ & & ⋮ & & ⋮ \\ {t}_{il}^{q} {f}_{i1} & ⋯ & {t}_{ik}^{q} {f}_{ik} & ⋯ & {t}_{iM}^{q} {f}_{iM} \\ ⋮ & & ⋮ & & ⋮ \\ {t}_{Nl}^{q} {f}_{Nl} & ⋯ & {t}_{Nk}^{q} {f}_{Nk} & ⋯ & {t}_{NM}^{q} {f}_{NM}\end{matrix} ] .$$

If spares are available, the downtime for a given scenario, q, is thus:

$${r}_{q}^{s} = [ {\sum }_{i = 1}^{N} {t}_{i1}^{q} {f}_{i1} ⋯ {\sum }_{i = 1}^{N} {t}_{ik}^{q} {f}_{ik} ⋯ {\sum }_{i = 1}^{N} {t}_{iM}^{q} {f}_{iM} ] .$$

Likewise, if spare components are unavailable, the downtime for the kth inventory item at the ith location is:

$$[ \begin{matrix}{τ}_{1} {f}_{11} & ⋯ & {τ}_{k} {f}_{1 k} & ⋯ & {τ}_{M} {f}_{1 M} \\ ⋮ & & ⋮ & & ⋮ \\ {τ}_{1} {f}_{i1} & ⋯ & {τ}_{k} {f}_{ik} & ⋯ & {τ}_{M} {f}_{iM} \\ ⋮ & & ⋮ & & ⋯ \\ {τ}_{1} {f}_{N1} & ⋯ & {τ}_{k} {f}_{Nk} & ⋯ & {τ}_{M} {f}_{NM}\end{matrix} ] .$$

If spares are unavailable, the downtime for a given scenario, q, is thus:

$${r}_{q}^{\overline{S}} = [ {\sum }_{i = 1}^{N} {τ}_{1} {f}_{i1} ⋯ {\sum }_{i = 1}^{N} {τ}_{k} {f}_{ik} ⋯ {\sum }_{i = 1}^{N} {τ}_{M} {f}_{iM} ] .$$

Accounting for the stockout probability,

$$\begin{matrix}{r}_{q}^{S} = [ \begin{matrix}{r}_{q1}^{S} & ⋯ & {r}_{qk}^{S} & ⋯ & {r}_{qM}^{S}\end{matrix} ] \\ = [ \begin{matrix}{\sum }_{i = 1}^{N} {t}_{i1}^{q} {f}_{i1} {u}_{i} & ⋯ & {\sum }_{i = 1}^{N} {t}_{ik}^{q} {f}_{ik} {u}_{i} & ⋯ & {\sum }_{i = 1}^{N} {t}_{iM}^{q} {f}_{iM} {u}_{i}\end{matrix} ] ,\end{matrix}$$

where

$$\begin{matrix}{u}_{i} = ( 1 - {p}_{1 k}^{q} ) & if {I}_{i}^{q} = 1 \\ = ( 1 - {p}_{2 k}^{q} ) & if {I}_{i}^{q} = 2\end{matrix} .$$

In addition,

$$\begin{matrix}{r}_{q}^{\overline{S}} = [ \begin{matrix}{r}_{q1}^{\overline{S}} & ⋯ & {r}_{qk}^{\overline{S}} & ⋯ & {r}_{qM}^{\overline{S}}\end{matrix} ] \\ = [ \begin{matrix}{\sum }_{i = 1}^{N} {τ}_{1} {f}_{i1} {u}_{i} & ⋯ & {\sum }_{i = 1}^{N} {τ}_{k} {f}_{ik} {u}_{i} & ⋯ & {\sum }_{i = 1}^{N} {τ}_{M} {f}_{iM} {u}_{i}\end{matrix} ] ,\end{matrix}$$

where

$$\begin{matrix}{u}_{i} = {p}_{1 k}^{q} & if {I}_{i}^{q} = 1 \\ = {p}_{2 k}^{q} & if {I}_{i}^{q} = 2\end{matrix} .$$

Then,
r_{q}=[r_{q1} . . . r_{qk} . . . r_{qM}],
where r_{qk}=r_{qk}^{S}+r_{qk}^{\overline{S}}.

The total downtime for a 2-warehouse node centralized warehouse configuration may be computed as follows:

$$r = [ \begin{matrix}{r}_{11} & ⋯ & {r}_{1 k} & ⋯ & {r}_{1 M} \\ ⋮ & & ⋮ & & ⋮ \\ {r}_{q1} & ⋯ & {r}_{qk} & ⋯ & {r}_{qM} \\ ⋮ & & ⋮ & & ⋮ \\ {r}_{C1} & ⋯ & {r}_{Ck} & ⋯ & {r}_{CM}\end{matrix} ] .$$

The total downtime for each scenario, q is thus:

$${\sum }_{k = 1}^{M} {r}_{qk} .$$

The total downtime for the 2-warehouse node centralized warehouse configuration is:

$${DT}^{C2} = {[ \begin{matrix}{\sum }_{k = 1}^{M} {r}_{1 k} & ⋯ & {\sum }_{k = 1}^{M} {r}_{qk} & ⋯ & {\sum }_{k = 1}^{M} {r}_{Ck}\end{matrix} ]}^{T} .$$

The ranking of total downtime is given by:

$${R}^{C} = {Rank [ \begin{matrix}{\sum }_{k = 1}^{M} {r}_{1 k} & ⋯ & {\sum }_{k = 1}^{M} {r}_{qk} & ⋯ & {\sum }_{k = 1}^{M} {r}_{Ck}\end{matrix} ]}^{T} .$$

In reality, the real or actual value of the parameters used above (e.g., availability parameters) at any one time is uncertain. As such, in another embodiment, the uncertainty of such parameters may be modeled by their respective probability distributions. Notably, the value of each variable is sampled using the associated probability distribution using, for example, a Latin Hypercube sampling technique. The Latin Hypercube sampling technique is a stratified sampling technique that will accurately recreate the probability distributions specified by the distribution functions in fewer iterations than traditional sampling techniques, such as Monte Carlo sampling.

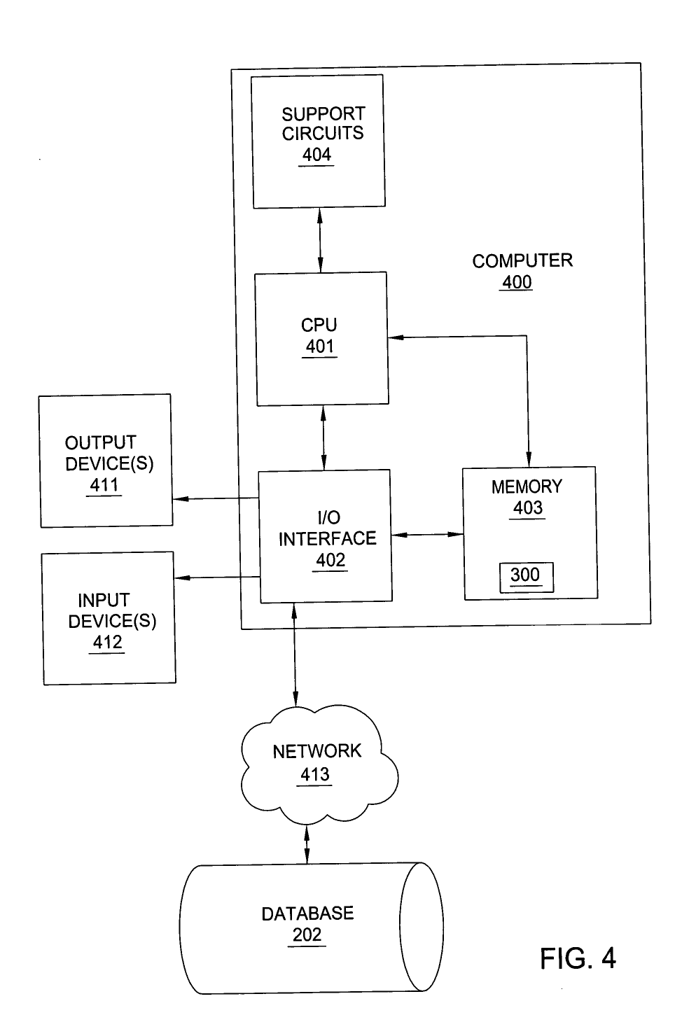

FIG. 4 is a block diagram depicting an exemplary embodiment of a computer 400 suitable for implementing processes and methods described above. The computer 400 includes a central processing unit (CPU) 401, a memory 403, various support circuits 404, and an I/O interface 402. The CPU 401 may be any type of microprocessor known in the art. The support circuits 404 for the CPU 402 include conventional cache, power supplies, clock circuits, data registers, I/O interfaces, and the like. The I/O interface 402 may be directly coupled to the memory 403 or coupled through the CPU 401. The I/O interface 402 may be coupled to various input devices 412 and output devices 411, such as a conventional keyboard, mouse, printer, display, and the like. In addition, the I/O interface 402 may be coupled to a network 413 and may be adapted for communication with the database 202 to receive and transmit data, such as data files and the like.

The memory 403 may store all or portions of one or more programs and/or data to implement the processes and methods described above. Although the invention is disclosed as being implemented as a computer executing a software program, those skilled in the art will appreciate that the invention may be implemented in hardware, software, or a combination of hardware and software. Such implementations may include a number of processors independently executing various programs and dedicated hardware, such as application specific integrated circuits (ASICs).

The computer 400 may be programmed with an operating system, which may be OS/2, Java Virtual Machine, Linux, Solaris, Unix, Windows, Windows95, Windows98, Windows NT, and Windows2000, WindowsME, and WindowsXP, among other known platforms. At least a portion of an operating system may be disposed in the memory 403. The memory 403 may include one or more of the following random access memory, read only memory, magneto-resistive read/write memory, optical read/write memory, cache memory, magnetic read/write memory, and the like, as well as signal-bearing media as described below. The memory 403 may store all or a portion of the warehouse and location optimization process 300 of FIG. 3.

An aspect of the invention is implemented as a program product for use with a computer system. Program(s) of the program product defines functions of embodiments and can be contained on a variety of signal-bearing media, which include, but are not limited to: (i) information permanently stored on non-writable storage media (e.g., read-only memory devices within a computer such as CD-ROM or DVD-ROM disks readable by a CD-ROM drive or a DVD drive); (ii) alterable information stored on writable storage media (e.g., floppy disks within a diskette drive or hard-disk drive or read/writable CD or read/writable DVD); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct functions of the invention, represent embodiments of the invention.

While the foregoing is directed to the illustrative embodiments of the present invention, other and further embodiments of the invention may be devised without departing from the basic scope thereof, and the scope thereof is determined by the claims that follow.

1. A method of optimizing spare component management for a network having a plurality of nodes, comprising:
obtaining availability parameters associated with an inventory of spare components; and
determining a plurality of management configurations in response to said availability parameters, each of said plurality of management configurations comprising at least one warehouse node selected from said plurality of nodes and a quantity of spare components in said inventory to be stored at said at least one warehouse node.

2. The method of claim 1, further comprising:
selecting at least one warehouse configuration for said plurality of nodes; and
repeating said determining step for each said warehouse configuration.

3. The method of claim 2, wherein said at least one warehouse configuration comprises a distributed warehouse configuration and a centralized warehouse configuration.

4. The method of claim 1, wherein said inventory of spare components is defined by a plurality of component types, and said availability parameters comprise at least one of a failure rate, a minimum repair time, a restocking time, and a stockout probability associated with each of said plurality of component types.

5. The method of claim 4, further comprising:
for each of said plurality of management configurations, computing an expected downtime of said network using said minimum repair time associated with at least one of said plurality of component types.

6. The method of claim 5, wherein, for each of said plurality of management configurations, said expected downtime of said network is further computed using delivery times from said at least one warehouse node to remaining ones of said plurality of nodes.

7. The method of claim 4, further comprising:
obtaining a critical repair time associated with each of said plurality of component types; and
for each of said plurality of management configurations, computing a number of expected critical repair time violations.

8. The method of claim 4, wherein said determining comprises:
obtaining a target stockout probability for each of said plurality of component types;
for each of said plurality of management configurations, computing said quantity of spare components to be stored at said at least one warehouse node by adjusting a quantity of each of said plurality of component types until said respective stockout probability is less than or equal to said respective target stockout probability.

9. The method of claim 1, wherein said inventory of spare components is obtained dynamically from said network.

10. The method of claim 1, wherein said availability parameters are obtained dynamically from said network.

11. A computer readable medium having stored thereon instructions that, when executed by a processor, cause the processor to perform a method of optimizing spare component management for a network having a plurality of nodes, comprising:
obtaining availability parameters associated with an inventory of spare components; and
determining a plurality of management configurations in response to said availability parameters, each of said plurality of management configurations comprising at least one warehouse node selected from said plurality of nodes and a quantity of spare components in said inventory to be stored at said at least one warehouse node.

12. The computer readable medium of claim 11, further comprising:
selecting at least one warehouse configuration for said plurality of nodes; and
repeating said determining step for each said warehouse configuration.

13. The computer readable medium of claim 12, wherein said at least one warehouse configuration comprises a distributed warehouse configuration and a centralized warehouse configuration.

14. The computer readable medium of claim 11, wherein said inventory of spare components is defined by a plurality of component types, and said availability parameters comprise at least one of a failure rate, a minimum repair time, a restocking time, and a stockout probability associated with each of said plurality of component types.

15. The method of claim 4, further comprising:
for each of said plurality of management configurations, computing an expected downtime of said network using said minimum repair time associated with at least one of said plurality of component types.

16. The computer readable of claim 15, wherein, for each of said plurality of management configurations, said expected downtime of said network is further computed using delivery times from said at least one warehouse node to remaining ones of said plurality of nodes.

17. The computer readable medium of claim 14, further comprising:
obtaining a critical repair time associated with each of said plurality of component types; and
for each of said plurality of management configurations, computing a number of expected critical repair time violations.

18. The computer readable medium of claim 14, wherein said determining comprises:
obtaining a target stockout probability for each of said plurality of component types;
for each of said plurality of management configurations, computing said quantity of spare components to be stored at said at least one warehouse node by adjusting a quantity of each of said plurality of component types until said respective stockout probability is less than or equal to said respective target stockout probability.

19. An apparatus for optimizing spare component management for a network having a plurality of nodes, comprising:
means for obtaining availability parameters associated with an inventory of spare components; and
means for determining a plurality of management configurations in response to said availability parameters, each of said plurality of management configurations comprising at least one warehouse node selected from said plurality of nodes and a quantity of spare components in said inventory to be stored at said at least one warehouse node.

20. A system optimizing spare component management for a network having a plurality of nodes, comprising:
a processing unit having access to one or more storage devices;
at least a portion of the one or more storage devices storing an inventory of spare components and availability parameters associated with said inventory;
at least another portion of said one or more storage devices having a program product configured to determine a plurality of management configurations in response to said availability parameters, each of said plurality of management configurations comprising at least one warehouse node selected from said plurality of nodes and a quantity of spare components in said inventory to be stored at said at least one warehouse node.
